(19) United States
(12) Patent Application Publication
(10) Pub. No.: US 2009/0096940 A1
(43) Pub. Date: Apr. 16, 2009

(54) Display frame

(76) Inventor: Michael Z. Scheffer, Rolla, MO (US)

Correspondence Address: DOUGLAS E. WARREN;ATTORNEY AT LAW, P.O. BOX 6727, CHESTERFIELD, MO, 63006, US

(21) Appl. No.: 11/974,810

(22) Filed: Oct. 16, 2007

(51) Int. Cl. H04N 5/64

(52) U.S. Cl. 348/836; 348/E05.128

(57) ABSTRACT

A display frame having removable image holders that can hold images such as photographs between the front and rear surfaces of the image holders wherein the image holders can be easily installed or removed without removing the display frame from the surface to which the display frame is mounted. The display frame can also include a plurality of hooks and a front mounting surface. The front mounting surface can be utilized to mount other objects or images or can be used as an art surface upon which artwork can be painted or drawn or otherwise artistically used.

### CROSS REFERENCE TO RELATED APPLICATIONS

Not applicable.

### STATEMENT REGARDING FEDERALLY SPONSORED RESEARCH

Not Applicable.

### BACKGROUND OF THE INVENTION

This invention relates to an apparatus for holding and displaying images and, and more specifically, to a unique display frame assembly that combines the ability to hold and display photographic images with the ability to allow the end user the convenience of installing and removing such images without removing the display frame from the surface to which the display frame is mounted, and that can provide coat hooks and a working surface upon which a user may dispose a variety of objects and images that the user would like to display in conjunction with the images displayed within the image holders of the invention.

### SUMMARY OF THE INVENTION

In accordance with the present invention, a new type of display frame is disclosed wherein the image holder includes a plurality of generally flexible image holders for insertion and display of images such as photographs with the convenience of such insertion and/or removal of images without removing the display frame from the surface to which the display frame is attached. In various embodiments of the invention the display frame can include a mounting surface located near the flexible image holders such that the mounting surface is capable of allowing a user to mount objects and images onto the mounting surface. In other embodiments of the present invention, the display frame includes a plurality of coat hooks or other hanging devices upon which coats, jackets, hats or other objects can be hung.

### DESCRIPTION OF THE DRAWINGS

In the accompanying drawings which form part of the specification:

FIG. 1 shows a perspective view of the front of one embodiment of the present invention.

FIG. 2 shows a perspective view of the back of one embodiment of the present invention.

FIG. 3 shows a horizontal section through one embodiment of the present invention.

Corresponding reference numerals indicate corresponding steps or parts throughout the several figures of the drawings.

While several embodiments of the present invention are illustrated in the above referenced drawings and in the following description, it is understood that the embodiments shown are merely examples of a single preferred embodiment offered for the purpose of illustration only and that various changes in construction may be resorted to in the course of manufacture in order that the present invention may be utilized to the best advantage according to circumstances which may arise, without in any way departing from the spirit and intention of the present invention, which is to be limited only in accordance with the claims contained herein.

### DETAILED DESCRIPTION OF AT LEAST ONE EMBODIMENT OF THE INVENTION

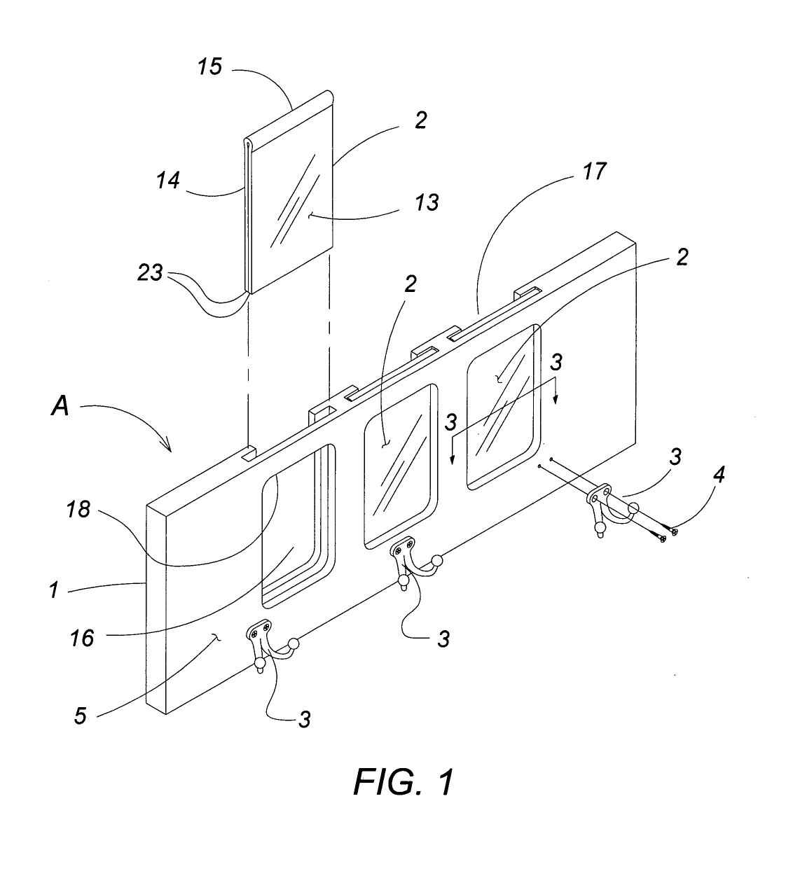

A preferred embodiment of the display frame A of the present invention is illustrated in FIG. 1. In this embodiment, the display frame A comprises a main frame element 1, a plurality of image holders 2, a plurality of hooks 3 and a plurality of fasteners 4 that hold the plurality of hooks onto a mounting surface 5 of the main frame element. In the present embodiment, the main frame element 1 is about 24.00 inches in length, about 8.75 inches in height, and about 0.75 inches in thickness and is made from a composite wood material such as medium density plywood. It will be appreciated by those of skill in the art that the main frame element 1 may also be made of other materials and still remain within the scope of the present invention. For example, solid wood material, laminated plywood material, resin particle board, material, composites of wood and plastics, or any other material may be used as long as the material selected to make the main frame element is sufficiently rigid enough to allow the present invention to fulfill all the characteristics of the embodiments of the invention as described herein, and can be configured as shown herein to allow for the installation and removal of the plurality of image holders 2.

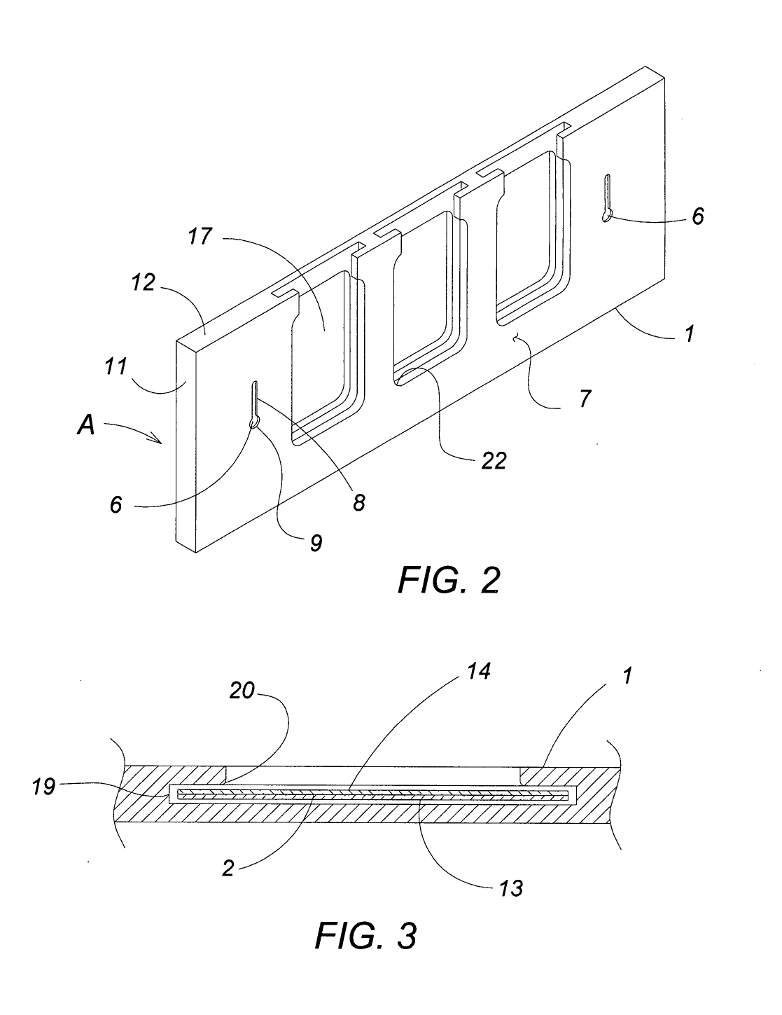

FIG. 2 shows a back view of one embodiment of the present invention and discloses a plurality of wall hanger openings 6 disposed on the back surface 7 of the main frame element 1. In this embodiment, the wall hanger openings 6 are configured to comprise a longitudinal slot 8 coupled at a distal end of the wall hanger slot with a generally circular opening 9 at a proximate end of the wall hanger slot wherein the generally circular opening has a diameter greater than the width of the longitudinal slot. It is understood that this configuration of the plurality of wall hanger openings 6 allows each of the wall hanger openings to accept a wall mounted faster or hanger that has a generally rounded head that first fits into the generally circular opening 9 and then allows the head to move into the longitudinal slot in a manner that acts to at least partially encapsulate the rounded head of the wall hanger within the longitudinal slot. In the present embodiment, there are two wall hanger openings 6 located sufficiently close to the edges 11 of the main frame element 1 and sufficiently near the top edge 12 of the main frame element to locate wall hanger devices sufficiently above the horizontal center of gravity of the display frame A to enhance the balance of the display frame A as it is hanging on a wall. Other types of wall hanger openings 6 can be used in other embodiments of the present invention as long as the type of wall hanger opening selected allows the display frame A to adequately mounted onto either a vertical or horizontal surface as preferred by the user.

Referring again to FIG. 1, the image holders 2 comprise a front window 13, a back window 14 and a joined edge 15. The joined edge 15 may be generated from the arcuate portion that results when a single piece of material is folded about 180 degrees. Alternatively, the joined edge 15 may also be formed by joining two pieces of material together to form a flexible joint such as, for example, when two pieces of matching glass elements are joined at one edge with a flexible hinged material such as tape. The image holders 2 of the present embodiment are made by folding a single piece of acrylic or plastic material about 180 degrees to result in the general shape of a hair pin. Due to the general flexible nature of the acrylic or plastic material used to make the image holders 2 of the present embodiment, the bottom ends 23 of the image holders can be spread apart a sufficient amount to allow for images such as photographs to be slipped between the front window 13 and the back window 14 of the image holder.

It is understood that while the image holder 2 of the present embodiment is made from either an acrylic or plastic material, any other material can also be used as long as the material selected allows images placed within the image holder 2 to be displayed through the plurality of display openings 16 in the main frame element 1 and is either flexible enough or is joined in a manner that allows for the bottom ends 23 of the image holder to be spread apart a sufficient amount to insert an image such as a photograph.

The main frame element 1 also comprises a plurality of display windows 16. The plurality of display windows 16 allow the images disposed within the image holders 2 to be viewed when the image holders are disposed within a plurality of mounting slots 17 in the main frame element 1. It must be noted that while the present embodiment shows a plurality of display windows 16 in the main frame element 1, it is understood that a display frame A having only one display window is also intended to be within the scope of the present invention. Likewise, it is also understood that the quantity of elements related to the display windows 16, such as image holders 2 and mounting slots 17, are to adjusted as needed to match the actual number of display windows used in the particular embodiment of the present invention that is preferred.

Each of the plurality of display openings 16 is generally rectangular in shape and has a radius 18 at each of its four corners. It is understood that the plurality of display windows 16 may be of other shapes and still remain within the intended scope of the present invention. For example, the plurality of display windows 16 may be in the shape of a square, a circle, an oval, a star, a circle, a polygon, or any other geometric shape—including an irregular arcuate shape and still be within the scope of the present invention.

The plurality of mounting slots 17 are disposed on the back surface 7 of the main frame element 1. The plurality of mounting slots 17 for the present invention are as shown in FIG. 3 and can comprise a slot 19 located on at least the two sides of the mounting slots and also include at least a pair of tabs 20 also located on at least the two sides of the mounting slots. When the image holder 2 is placed within the mounting slot 17, the image holder is slideably held into position within the mounting slot by the material that comprises the slots 19. In the present embodiment, the bottom corners 21 of the mounting slots 19 have a radius 22, while in yet other embodiments the mounting slots have no appreciable radius.

In operation, the present embodiment of this invention allows a user to remove at least one image holder 2 from its associated mounting slot 17. After the image holder 2 is removed from the mounting slot 17, the bottom ends 23 of the image holder are carefully spread apart by the user to allow the user to insert an image such as a photograph between the front window 13 and the back window 14 of the image holder 2. When the image is properly emplaced within the image holder 2, the image holder is re-inserted into the mounting slot 17 and allowed to drop to the bottom of the mounting slot 17. The tabs 20 and the shape of the slots 19 act to maintain the image holder 2 in slidable position within the mounting slot 17. The same process can be repeated for each of the other plurality of image holders 2 without the display frame A being removed from the surface to which the display frame is mounted.

It will be appreciated that the front mounting surface 5 can also be used in alternative embodiments for purposes other that the mounting of the plurality of hooks 3 and fasteners 4. For example, it will be understood that it is an additional purpose of the front mounting surface 5 to be used to mount other objects or images as may be selected and preferred by the user. Additionally, the user may also utilize the front mounting surface 5 as a work surface upon which art can be drawn or placed. For example, the user can paint the front mounting surface 5 to generate artwork upon the front mounting surface. Indeed, the front mounting surface 5 is provided to allow the user to utilize the user's imagination to dispose any number of objects or artwork on the mounting surfaces that a user finds attractive.

While the above description describes various embodiments of the present invention, it will be clear that the present invention may be otherwise easily adapted to fit any configuration where a display frame is required. Additionally, as various changes could be made in the above constructions without departing from the scope of the invention, it is also intended that all matter contained in the above description or shown in the accompanying drawings shall be interpreted as illustrative and not in a limiting sense. The scope of the invention should be determined by the appended claims and their legal equivalents, rather than by the examples given.

What is claimed is:

1. A display frame comprising:
a main frame element having at least one display window and at least one mounting slot wherein the mounting slot is disposed substantially near a center of the display window;
at least one image holder wherein the image holder is sized and configured to slideably fit into the mounting slot in the main frame element.

2. The display frame of claim 1 wherein the image holder is made from a sufficiently clear and flexible material such that the image holder comprises a front window and a rear window that can be temporarily spaced apart to allow at least one image to be positioned and substantially displayed between the front window and the rear window.

3. The display frame of claim 2 wherein the image holder further comprises a joined edge.

4. The display frame of claim 3 wherein the image holder is made by folding a single piece of material about 180 degrees to result in a generally hair pin shape at the joined edge.

5. The display frame of claim 4 wherein the image holder is made from one of either an acrylic material or a plastic material.

6. The display frame of claim 5 wherein the display window allows the at least one image disposed within the image holder to be viewed when the image holder is disposed within the mounting slot in the main frame element.

7. The display frame of claim 6 wherein display window has a geometric shape of at least one of either a rectangle, a square, a circle, an oval, a star, a circle, a polygon, or an irregular arcuate shape.

8. The display frame of claim 7 wherein each of the display windows is in the shape of a polygon.

9. The display frame of claim 8 wherein the mounting slot is disposed on a back surface of the main frame element.

10. The display frame of claim 9 wherein the mounting slot comprises a slot located on at least two sides of the mounting slot and at least a pair of tabs located on at least two sides of the mounting slot.

11. The display frame of claim 10 further comprising a plurality of wall hanger openings disposed on the back surface of the main frame element.

12. The display frame of claim 11 wherein each of the plurality of wall hanger openings is configured to comprise a longitudinal slot at a distal end of each of the plurality of wall hanger openings coupled with a generally circular opening at a proximate end of each of the plurality of wall hanger openings wherein the generally circular opening has a diameter greater than the width of the longitudinal slot.

13. The display frame of claim 12 wherein the main frame element is made from a material selected from the group consisting of medium density plywood, solid wood material, laminated plywood material, resin particle board, composites of wood and plastic, and any other material sufficiently rigid enough to hold the plurality of image holders.

14. The display frame of claim 13 wherein the main frame element is about 24.00 inches in length, about 8.75 inches in height, and about 0.75 inches in thickness and is made from a composite wood material.

15. The display frame of claim 13 further comprising at least one hook and at least one fastener that holds the hooks onto a front mounting surface of the main frame element.

16. The display frame of claim 15 wherein the main frame element further comprises a work surface wherein within the general area of the front mounting surface such that a user may mount objects on the work surface and wherein the user can utilize the work surface as a base upon which artwork can be drawn or mounted.

17. A display frame comprising:
a main frame element having at least one display window and at least one mounting slot wherein the mounting slot is disposed substantially near a center of the display window;
at least one image holder wherein the image holder is sized and configured to slideably fit into the mounting slot in the main frame element, and wherein the image holder is made from a sufficiently clear and flexible material such that the image holder comprises a front window and a rear window that can be temporarily spaced apart to allow at least one image to be positioned and substantially displayed between the front window and the rear window.

18. The display frame of claim 17 wherein the display window has a geometric shape of at least one of either a rectangle, a square, a circle, an oval, a star, a circle, a polygon, or an irregular arcuate shape, and further comprising a plurality of wall hanger openings disposed on the back surface of the main frame element wherein each of the plurality of wall hanger openings is configured to comprise a longitudinal slot at a distal end of each of the plurality of wall hanger openings coupled with a generally circular opening at a proximate end of each of the plurality of wall hanger openings wherein the generally circular opening has a diameter greater than the width of the longitudinal slot.

19. The display frame of claim 18 further comprising at least one hook and at least one fastener that holds the hook onto a front mounting surface of the main frame element, and wherein the main frame element further comprises a work surface wherein within the general area of the front mounting surface such that a user may mount objects on the work surface and wherein the user can utilize the work surface as a base upon which artwork can be drawn or mounted.

20. A display frame comprising:
a main frame element having a at least one display window and at least one mounting slot wherein the mounting slot is disposed substantially near a center of the display window; wherein the display window has a geometric shape of at least one of either a rectangle, a square, a circle, an oval, a star, a circle, a polygon, or an irregular arcuate shape; wherein the mounting slot is disposed on a back surface of the main frame element; wherein the mounting slot comprises a slot located on at least two sides of the mounting slot and at least a pair of tabs located on at least two sides of the mounting slot; and wherein the main frame element is made from a material selected from the group consisting of medium density plywood, solid wood material, laminated plywood material, resin particle board, composites of wood and plastic, and any other material sufficiently rigid enough to hold the plurality of image holders;
at least one image holder made from a sufficiently clear and flexible material such that the image holder comprises a front window and a rear window that can be temporarily spaced apart to allow at least one image to be positioned and substantially displayed between the front window and the rear window; wherein each the image holder is sized and configured to slideably fit into the mounting slot in the main frame element; wherein the image holder is made from one of either an acrylic material or a plastic material; and wherein the display window allows at least one image disposed within the image holder to be viewed when the image holder is disposed within the mounting slot in the main frame element;
a plurality of wall hanger openings disposed on the back surface of the main frame element wherein each of the plurality of wall hanger openings is configured to comprise a longitudinal slot at a distal end of each of the plurality of wall hanger openings coupled with a generally circular opening at a proximate end of each of the plurality of wall hanger openings wherein the generally circular opening has a diameter greater than the width of the longitudinal slot;
at least one hook and at least one fastener that holds the hook onto a front mounting surface of the main frame element; and
a work surface on the front mounting surface such that a user may mount objects on the work surface and wherein the user can utilize the work surface as a base upon which artwork can be drawn or mounted.
